(19) United States
(12) Patent Application Publication
(10) Pub. No.: US 2002/0184379 A1
(43) Pub. Date: Dec. 5, 2002

(54) Forwarding data packets

(76) Inventor: Geping Chen, Northborough, MA (US)

Correspondence Address: DENIS G. MALONEY, Fish & Richardson P.C., 225 Franklin Street, Boston, MA, 02110-2804, US

(21) Appl. No.: 10/036,010

(22) Filed: Dec. 26, 2001

Related U.S. Application Data
(60) Provisional application No. 60/295,601, filed on Jun. 4, 2001.

(51) Int. Cl. G06F 15/16

(52) U.S. Cl. 709/230

(57) ABSTRACT

A method to accommodate two different data structures when porting a protocol stack to a driver includes providing entries in a driver packet buffer structure to mimic a buffer structure of a ported protocol stack. The method also includes providing entries in the buffer structure of the ported protocol stack.

### CLAIM OF PRIORITY

This application claims priority under 35 USC §119(e) to U.S. Patent Application Serial No. 60/295,601, filed on Jun. 4, 2001, the entire contents of which are hereby incorporated by reference.

### BACKGROUND

This invention relates to network communications and in particular forwarding data packets.

Network communication requires a sender to send information over a network and a receiver to receive the information. The network is typically a group of two or more computer systems linked together. The information typically is sent in one or more packets of data.

A protocol is an agreed-upon format for transmitting data between the sender and the receiver. The protocol determines the type of error checking to be used, a data compression method, if any, how the sending device will indicate that it has finished sending a message, and how the receiving device will indicate that it has received a message. Software developers developing communications software prefer to port off-the-shelf protocol stacks to their driver code because it would be too costly and impractical to code a new protocol methodology.

### SUMMARY

In one aspect, the invention is a method to accommodate two different data structures when porting a protocol stack to a driver. The method includes providing entries in a driver packet buffer structure to mimic a buffer structure of a ported protocol stack. The method also includes providing entries in the buffer structure of the ported protocol stack.

This aspect may have one or more of the following embodiments. Providing entries in the driver packet buffer structure includes adding a flag entry to a data block of the driver packet buffer structure. The flag entry identifies any buffer generated in the driver and outside of the protocol stack. Providing entries in the driver packet buffer structure includes adding a pointer-to-header entry to a data block of the driver packet buffer structure. The pointer-to-header entry determines an appropriate freeing routine. Providing entries in the buffer structure of the ported protocol stack includes appending a flag entry to a message block of the buffer structure of the ported protocol stack. Providing entries in the buffer structure of the ported protocol stack includes appending a pointer-to-header entry to a data block of the buffer structure of the ported protocol stack. Providing entries in the driver packet data structure includes appending a data block of the driver packet data structure to have the same pointers as in a message block of the buffer structure of the ported protocol stack. Providing entries in the driver packet data structure includes appending a data block of the driver packet data structure to have the same entries as in a data block of the buffer structure of the ported protocol stack. Providing entries in the driver packet data structure includes appending a data block of the driver packet data structure to have the same data as in an actual data buffer of the buffer structure of the ported protocol stack.

In another aspect, the invention is an apparatus that includes a memory that stores executable instructions for accommodating two different data structures when porting a protocol stack to a driver and a processor. The processor executes instructions to provide entries in a driver packet buffer structure to mimic a buffer structure of a ported protocol stack and to provide entries in the buffer structure of the ported protocol stack.

The apparatus aspect of the invention may have one or more of the following features. The instructions to provide entries in the driver packet buffer structure include adding a flag entry to a data block of the driver packet buffer structure. The flag entry identifies any buffer generated in the driver and outside of the protocol stack. The instructions to provide entries in the driver packet buffer structure include adding a pointer-to-header entry to a data block of the driver packet buffer structure. The pointer-to-header entry determines an appropriate freeing routine.

In still another aspect, the invention is an article that includes a machine-readable medium that stores executable instructions for accommodating two different data structures when porting a protocol stack to a driver. The instructions causing a machine to provide entries in a driver packet buffer structure to mimic a buffer structure of a ported protocol stack and to provide entries in the buffer structure of the ported protocol stack.

The article aspect of the invention may include one or more of the following embodiments. The instructions causing a machine to provide entries in the driver packet buffer structure include adding a flag entry to a data block of the driver packet buffer structure. The flag entry identifies any buffer generated in the driver and outside of the protocol stack. The instructions causing a machine to provide entries in the driver packet buffer structure include adding a pointer-to-header entry to a data block of the driver packet buffer structure. The pointer-to-header entry determines an appropriate freeing routine.

Some or all of the aspects of the invention described above may have some or all of the following advantages. The invention improves packet forwarding speed by eliminating data copying between two different buffer structures. The invention can be used for almost any type of porting method in a communications software development effort. Using this invention in the communications software development effort, will decrease the time spent in the development phase, which in turn, can reduce a products time to market and thus provide a competitive advantage. The invention also dramatically improves the software scalability.

### DESCRIPTION OF THE DRAWINGS

FIG. 1A is a block diagram of a network communications system.

FIG. 1B is a block diagram of data communications software.

FIG. 2 is a flow chart of a process to accommodate two different data structures when porting a protocol stack to a driver.

FIG. 3 is a block diagram of a driver packet buffer structure.

FIG. 4 is a block diagram of a protocol stack buffer segment.

FIG. 5 is a block diagram of a revised protocol stack buffer segment using the process of FIG. 2.

FIG. 6 is a block diagram of a revised driver packet buffer structure using the process of FIG. 2.

FIG. 7 is a block diagram of packets flows within the communications software.

### DESCRIPTION

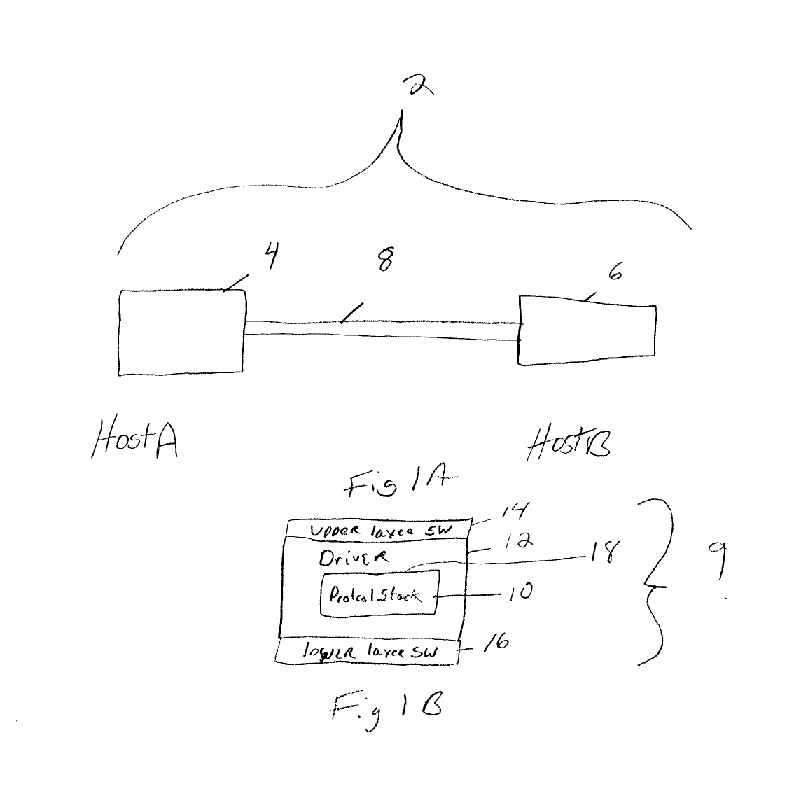

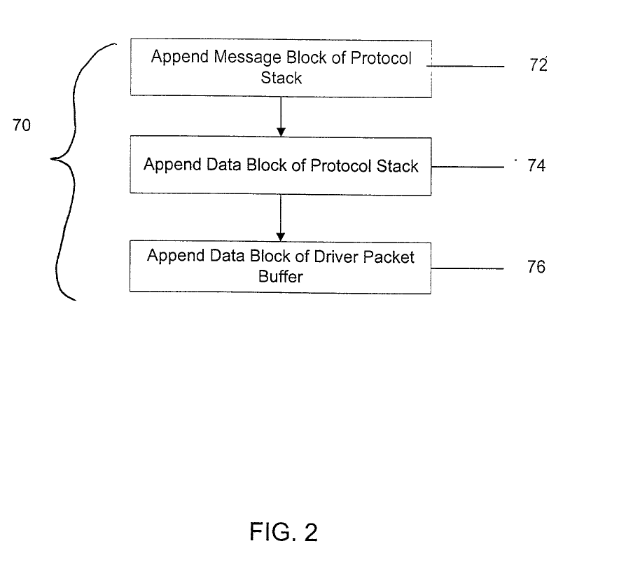

Referring to FIGS. 1A, 1B and 2, a network communications system 2 connects a host A 4 and a host B 6 at many different layers. One of those layers, a data link layer 8, ensures that the transmission from host A 4 to host B 6 is free of transmission errors. Communications between host A 2 and host B 4 is facilitated through software. A protocol stack 10 from data link layer 8 is ported into a driver 12 of a data communications software 9. During the course of communications, packets can pass through an upper layer software 14, a driver 12, a protocol stack 10 and a lower layer 16. Whenever a packet is processed through a protocol stack/driver interface 18 a copying process takes place. Thus, a packet that travels from the upper software layer 14 to a lower software layer 16 crosses protocol stack/driver interface 18 twice requiring two copying operations. As discussed below, the copying process is necessary because the ported protocol stack 10 and driver code 12 have different data buffer structures. Every time a copying process takes place, the movement of the packet is delayed. As will be explained in detail below, a process 70 accommodates the two different data buffer structures when porting a protocol stack to a driver and eliminates the copying necessary when a packet passes between interface 18.

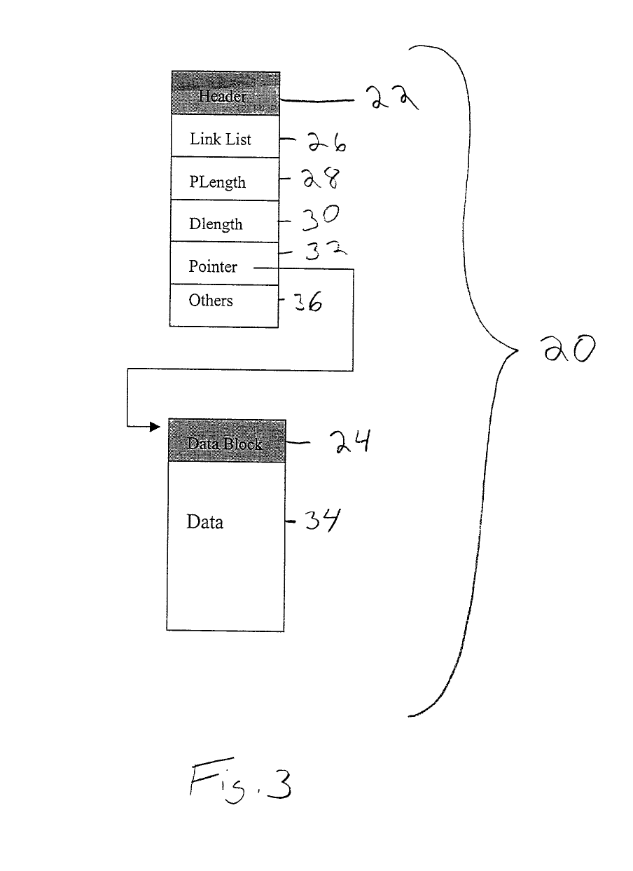

Referring to FIG. 3, without using process 70, a driver packet buffer structure 20 includes a header portion 22 and a data block portion 24. Header portion 22 includes a link list section 26, a p length section 28, a d length section 30, a pointer section 32 that points to data block 24 holding data 34, and an other section 36 for miscellaneous information. The p length section 28 stores the length of driver packet buffer structure 20. The d length section 30 stores the length of data block 24.

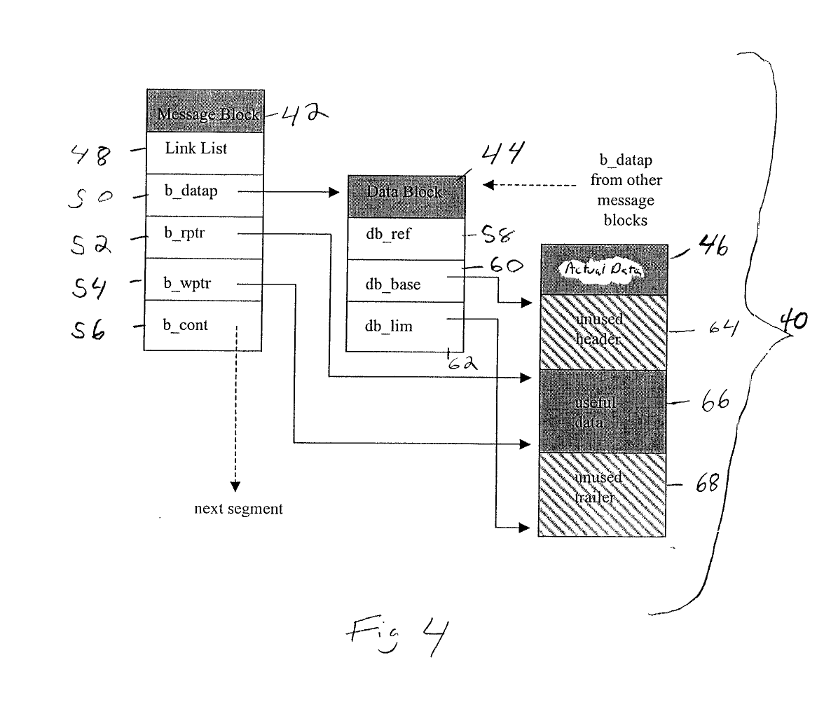

Referring to FIG. 4, without using process 70, a protocol stack buffer segment 40 includes a message block 42, a data block structure 44 and an actual data buffer 46. The actual data contained in a message is stored in actual data buffer 46.

Message block section 42 includes a link list pointer 48, a b_datap pointer 50, a b_rptr pointer 52, a b_wptr pointer 54 and a b_cont pointer 56. The b_datap pointer 50 points to data block section 44. The b_rptr pointer 52 points to the first unread data byte in a useful data section 66 of actual data buffer 46. The b_wptr points to the first unwritten byte of useful data section 66. The b_cont pointer points to the next message block and is used to link message blocks together when a message includes more than one message section.

Data block structure 44 stores message information. Within data block structure 44, a db_ref member 58 records the number of message pointers that point to data block structure 44. The db_ref member 58 keeps track of references in data block structure 44 and prevents the data block structure from being deallocated until all the message blocks are finished using the data block structure. A db_base member 60 points to the first byte in actual data buffer 46, which is located in an unused header 64. A db_lim 62 points to the last byte plus one of actual data buffer 46, which is located in an unused trailer 68.

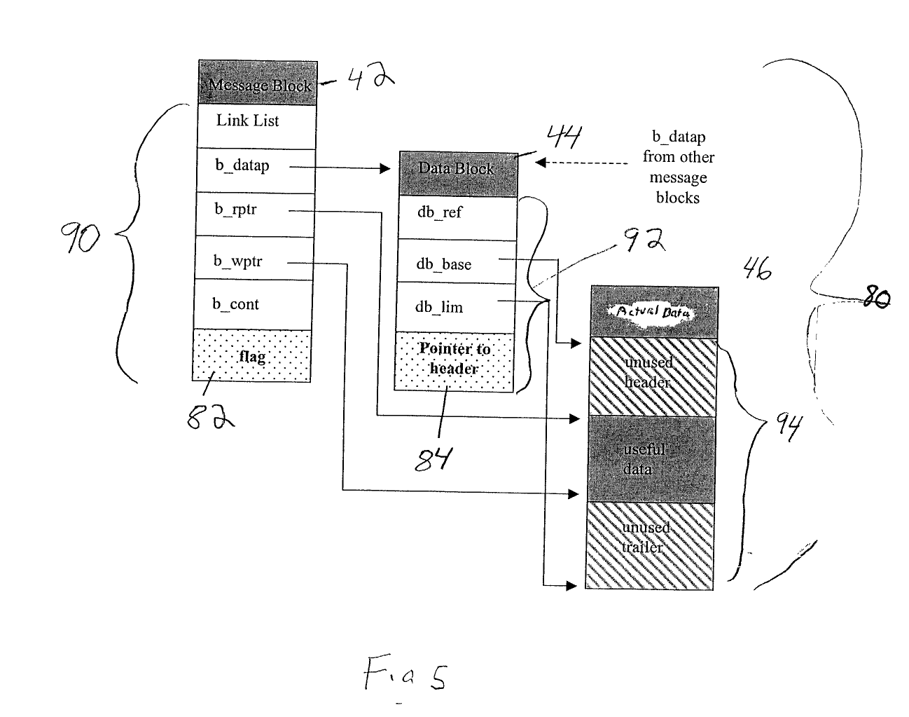

Referring to FIG. 5, process 70 appends (72) a flag entry 82 to message block 42 to generate a revised protocol stack buffer segment 80 (FIG. 1). Flag entry 82 flags any buffer that is generated in driver code 12 outside protocol stack 10 (FIG. 1). The flag entry 82 is used to account for the different freeing routines used in the differing data block structures. Process 70 also appends (74) appends data block structure 44 to include a pointer-to-header entry 84. The pointer-to-header entry 84 points to header portion 22.

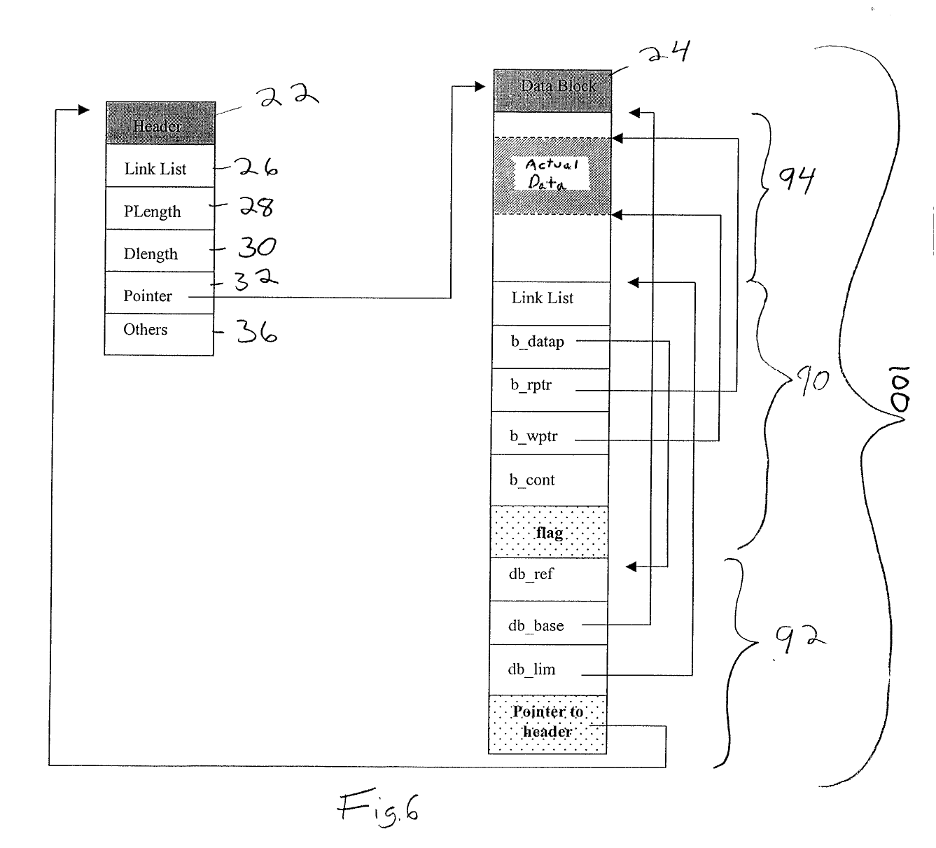

Referring to FIG. 6, process 70 appends data block 24 to generate a revised driver packet buffer structure 100 (FIG. 1). Header portion 22 remains unchanged after using process 70. However, data block 24 is appended to include the same fields as in a revised protocol stack buffer segment 80. For example, data 94 in actual data buffer 46, a set of pointers 90 including flag entry 82 in message block 42 and a set of members 92 including pointer-to-header pointer 84 in data block structure 44 are all placed within data block 24. Pointers in the appended fields are properly initialized to reflect the actual pointer references. Since, the data block 24 has the same fields as in protocol stack buffer segment 80, information does not need to be copied when moving between protocol stack/driver interface 18.

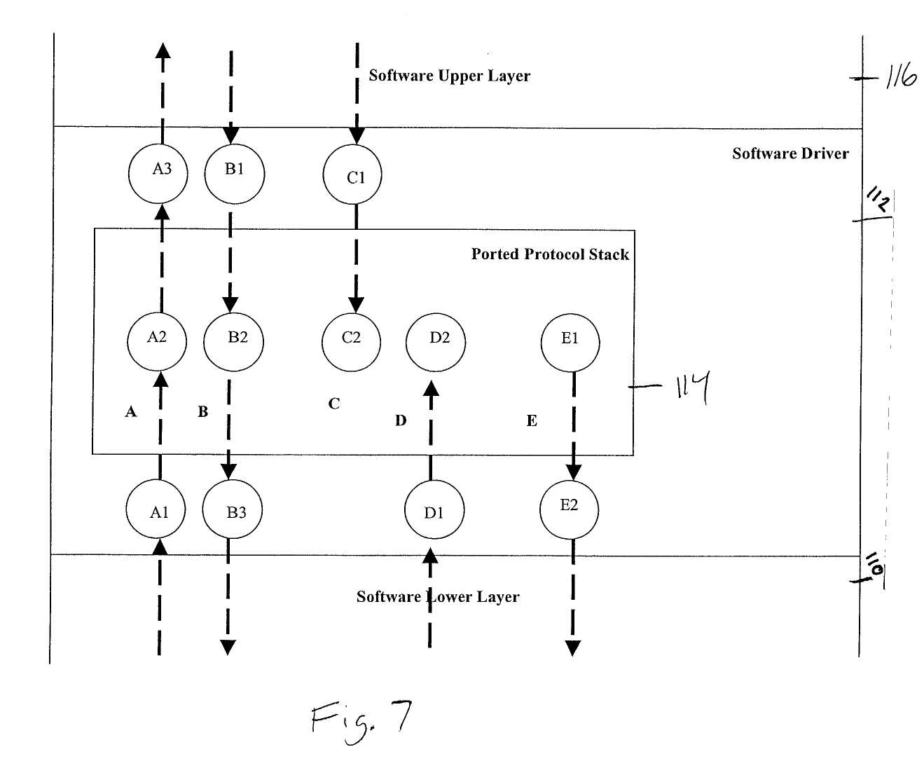

Referring to FIG. 7 exemplary packet flows (e.g., a packet flow A, a packet flow B, a packet flow C, a packet flow D, and a packet flow E) are shown after the protocol is ported to the driver using process 70. Each circle in FIG. 7 indicates a node. Packet flow A shows the flow when a packet passes through a software lower layer 110 through a driver 112 to a ported protocol stack 114 back through driver 112 to a software upper layer 116. Node A1 converts driver packet buffer structure 100 to protocol stack buffer segment 80 (FIG. 6) and sets flag entry 82 of the message buffer. Node A3 converts protocol stack buffer segment 80 back to driver packet buffer structure 100 by referencing the pointer-to-header entry 84. Packet Flow B has a similar flow to packet flow A except in an opposite direction.

Packet flow C and packet flow D are packet flows when the packet is freed in protocol stack buffer segment 80 after driver packet buffer structure 100 is converted to the protocol stack buffer segment. A freeing routine deallocates a message block. Protocol stack buffer segment 80 and driver packet buffer structure 100 each have their own freeing routines. In Node C2 and Node D2, the freeing routine used in the protocol stack is modified so that when the freeing routine sees flag entry 82 is set, the freeing routine uses the driver buffer's freeing routine instead of its own buffer freeing mechanism.

Packet flow E represents a flow of a packet when started in the protocol stack. In this flow, there are two possible outcomes of looking into the pointer-to-header entry 84. The first outcome has a short control packet (pointer-to-header entry 84 is not set). In node E2, the content of the packet is copied to a driver buffer.

The other outcome is when pointer-to-header entry 84 is set and flag entry 82 in message block 42 is not set. This is a retransmission data packet from the protocol stack. Node E2 converts the protocol buffer segment 80 to driver packet buffer structure 100 and frees the data block that is generated by protocol stack buffer segment 80. In this case, by looking at db_ref entry 58 duplicate driver buffer data is prevented from being sent out twice. For example, if db_ref entry 58 is greater than two, the buffer data is not sent out again.

By using process 70 in the communications software development effort, saves time in the development phase, which in turn, can reduce a communication software product's time to market. Reducing time to market provides a competitive advantage for a business. Process 70 also improves the software scalability while increasing the packet forwarding speed.

The invention is not limited to the specific embodiments described herein. For example, process 70 is used for almost any type of porting method in a communications software development effort. The invention is not limited to the specific processing order of FIG. 2. Rather, the blocks of FIG. 2 may be re-ordered, as necessary, to achieve the results set forth above.

Other embodiments not described herein are also within the scope of the following claims.

What is claimed is:

1. A method to accommodate two different data structures when porting a protocol stack to a driver, comprises:
providing entries in a driver packet buffer structure to mimic a buffer structure of a ported protocol stack; and
providing entries in the buffer structure of the ported protocol stack.

2. The method of claim 1 wherein providing entries in the driver packet buffer structure comprises adding a flag entry to a data block of the driver packet buffer structure.

3. The method of claim 2 wherein the flag entry identifies any buffer generated in the driver and outside of the protocol stack.

4. The method of claim 1 wherein providing entries in the driver packet buffer structure comprises adding a pointer-to-header entry to a data block of the driver packet buffer structure.

5. The method of claim 4 wherein the pointer-to-header entry determines an appropriate freeing routine.

6. The method of claim 1 wherein providing entries in the buffer structure of the ported protocol stack comprises appending a flag entry to a message block of the buffer structure of the ported protocol stack.

7. The method of claim 1 wherein providing entries in the buffer structure of the ported protocol stack comprises appending a pointer-to-header entry to a data block of the buffer structure of the ported protocol stack.

8. The method of claim 1, wherein providing entries in the driver packet data structure comprises:
appending a data block of the driver packet data structure to have the same pointers as in a message block of the buffer structure of the ported protocol stack.

9. The method of claim 1, wherein providing entries in the driver packet data structure comprises:
appending a data block of the driver packet data structure to have the same entries as in a data block of the buffer structure of the ported protocol stack.

10. The method of claim 1, wherein providing entries in the driver packet data structure comprises:
appending a data block of the driver packet data structure to have the same data as in an actual data buffer of the buffer structure of the ported protocol stack.

11. An apparatus comprising:
a memory that stores executable instructions for accommodating two different data structures when porting a protocol stack to a driver; and
a processor that executes the instructions to:
provide entries in a driver packet buffer structure to mimic a buffer structure of a ported protocol stack; and
provide entries in the buffer structure of the ported protocol stack.

12. The apparatus of claim 11 wherein to provide entries in the driver packet buffer structure comprises adding a flag entry to a data block of the driver packet buffer structure.

13. The apparatus of claim 12 wherein the flag entry identifies any buffer generated in the driver and outside of the protocol stack.

14. The apparatus of claim 11 wherein to provide entries in the driver packet buffer structure comprises adding a pointer-to-header entry to a data block of the driver packet buffer structure.

15. The apparatus of claim 14, wherein the pointer-to-header entry determines an appropriate freeing routine.

16. An article comprising a machine-readable medium that stores executable instructions for accommodating two different data structures when porting a protocol stack to a driver, the instructions causing a machine to:
provide entries in a driver packet buffer structure to mimic a buffer structure of a ported protocol stack; and
provide entries in the buffer structure of the ported protocol stack.

17. The article of claim 16 wherein to provide entries in the driver packet buffer structure comprises adding a flag entry to a data block of the driver packet buffer structure.

18. The article of claim 17 wherein the flag entry identifies any buffer generated in the driver and outside of the protocol stack.

19. The article of claim 16 wherein to provide entries in the driver packet buffer structure comprises adding a pointer-to-header entry to a data block of the driver packet buffer structure.

20. The article of claim 19 wherein the pointer-to-header entry determines an appropriate freeing routine.
